(19) United States
(12) Patent Application Publication
(10) Pub. No.: US 2016/0080903 A1
(43) Pub. Date: Mar. 17, 2016

(54) DIGITAL NETWORK OF LOCAL CONTENT NETWORK STATIONS

(71) Applicant: 1AppWorks, Inc., La Jolla, CA (US)

(72) Inventors: Neil R. Senturia, La Jolla, CA (US); Thomas C. Broadhead, La Jolla, CA (US); Clifford T. Boro, La Jolla, CA (US); Paul T. Love, La Jolla, CA (US)

(73) Assignee: 1AppWorks, Inc, La Jolla, CA (US)

(21) Appl. No.: 14/890,152

(22) PCT Filed: May 9, 2014
(86) PCT No.: PCT/US14/37590

§ 371 Date: Nov. 9, 2015

Related U.S. Application Data
(60) Provisional application No. 61/821,654, filed on May 9, 2013.
(60) Provisional application No. 61/943,905, filed on Feb. 24, 2014.
(60) Provisional application No. 61/985,353, filed on Apr. 28, 2014.

(51) Int. Cl. H04W 4/02; H04W 8/20

(52) U.S. Cl. CPC H04W 4/023; H04W 8/20

(57) ABSTRACT

Systems and methods related to a global network of local and/or hyper-local network stations are described herein. Such stations may be created, sponsored, or managed by various entities. In certain embodiments, the digital network of stations is accessible via a single mobile or internet application, enabling entities to create unique mobile experiences for consumers without needing to build and promote their own mobile applications. A partner entity, through its station, may act as a local concierge, providing recommendations to station visitors and connecting its station's visitors to local deals. The global network of stations is designed to strategically disseminate information to consumers who are identified as likely receptive to the information based, for example, on a consumer's location, location history, browsing history, station selection, interests, lifestyle choices, affiliations, biographical data, and/or current environmental data.

### CROSS-REFERENCE TO RELATED PATENT APPLICATIONS

This application claims the benefit of, and priority to, U.S. Provisional Application No. 61/821,654, filed May 9, 2013, entitled DIGITAL NETWORK OF LOCAL CONTENT NETWORK CHANNELS; U.S. Provisional Application No. 61/943,905, filed Feb. 24, 2014, entitled DIGITAL NETWORK OF LOCAL CONTENT NETWORK STATIONS; and U.S. Provisional Application No. 61/985,353, filed Apr. 28, 2014, entitled DIGITAL NETWORK OF LOCAL CONTENT NETWORK STATIONS; each of which is incorporated herein by reference in its entirety.

### BACKGROUND

1. Technical Field

The present technology relates to systems and methods for delivering content to network-connected computing devices. Particularly, the technology relates to systems and methods for providing content to computing devices based, at least in part, on the location of each device.

2. Description of the Related Art

Increasingly, consumers carry mobile phones, tablets, or other network-connected computing devices with them wherever they travel. Such network-connected computing devices can identify a consumer's location using signals received via the global positioning system (GPS) or wireless phone networks. Presently, with such technology, consumers can track their locations using map applications downloaded onto their computing devices. Consumers can also connect their computing devices to a venue's wireless network and/or to other nearby devices via Wi-Fi®, Bluetooth®, near field communications, or other radio frequency technology or other wireless communication technology. When connected to a network, it is possible for consumers to receive content through their computing devices, for example, via email, SMS text messages, push notifications, applications, and by browsing through content posted on websites. Consumers frequently receive emails from stores, other vendors, and daily deal providers that are of no interest or utility to many of the recipients. Without proven methods of effectively targeting particular consumers, vendors often use a spam-like approach, sending promotional emails to every email address they have on record. Such methods of content delivery can lead to content overload for consumers and are often extremely inefficient modes of promotion for vendors. Content delivered through such means is often, at best, irrelevant to a consumer, and it may cause a consumer annoyance and decreased productivity and lead the consumer to ignore all such promotional emails.

### SUMMARY

The systems and methods described herein each have several aspects, no single one of which is solely responsible for its desirable attributes. Without limiting the scope of this disclosure as expressed by the claims that follow, the more prominent features will now be discussed briefly. After considering this discussion, and particularly after reading the section entitled “Detailed Description,” one will understand how the sample features described herein provide for improved systems and methods of delivering content to consumers.

Valuable information about a consumer's socioeconomic status, tastes, and interests can often be deduced from the places a consumer visits and the organizations with which a consumer affiliates. For example, consumers at a particular hotel, shopping mall, professional conference, sporting event, or tradeshow are likely to share at least some similar tastes and interests. Similarly, members of the same house of worship, recreational sports league, or civic organization are likely to share at least some similar values and interests. Some embodiments herein are based upon the discovery that a need exists for a communication network configured to provide a consumer with content that is curated, at least in part, based on the consumer's location, and optionally, based on the consumer's location history and/or affiliations (e.g., memberships and interests). Also, some embodiments relate to the discovery that a need exists for a communication network configured to provide consumers with content that consumers view as relevant and valuable to them. Moreover, some embodiments relate to the recognition that today, many consumers have too many applications downloaded onto their mobile computing devices, making it difficult to organize and remember them all. Consequently, many downloaded applications go unused.

The systems and methods described herein may address one or more of the aforementioned needs. Embodiments described herein relate to a digital network designed to provide, for example, curated content to mobile computing devices via location or geography-based network stations. In various embodiments, the digital network is accessible via a single mobile or internet application, and the network enables a plurality of venues and other entities to maintain “micro-applications” or “stations” that are accessible to consumers who open the single digital network application. The systems and methods described herein thus break away from the conventional application model. Under the conventional application model, an entity that wishes to share content with customers must either have contact information (e.g., email address or phone number) to reach out to each customer or convince customers to download the entity's application. The entity's application is one of millions within an application store, and motivating people to seek it out and download it can be a challenge. Additionally, to develop an application with an attractive user experience is generally time and cost intensive, requiring the skill of software engineers to build, deploy, and update. The mobile application of various embodiments described herein thus changes this application paradigm. It eliminates the need for entities to create applications, thereby eliminating consumers' hurdles of application discovery and download and the surge in data usage that generally occurs when downloading an application.

The mobile application disclosed herein creates a single-entry-point digital network, which enables consumers to discover an entire universe of location-based micro-applications or stations. In certain embodiments, all stations within the digital network are available with a single download of the mobile application described herein, and for a consumer, the user experience within each station is similar or substantially similar to the user experience of an application with the added benefit that user information entered into one station or into the global application may be transferrable and accessible within other stations. In some embodiments, the stations are created, maintained, and/or sponsored by entities such as, for example, local venues or local organizations. In certain embodiments, each station includes curated content tailored to create a consumer user experience that is unique from other stations.

While connected to a network station, consumers may receive special invitations and commercial offers of likely relevance to individuals connected to the particular station. The invitations and offers may come directly from the entity maintaining the station or from one or more trusted affiliates who partner with the entity. In some embodiments, the trusted affiliates are stores, restaurants, local attractions, daily deal providers, or other vendors with whom the entity chooses to associate. While connected to the station, consumers may additionally or alternatively have access to a listing of trusted affiliates recommended by the entity maintaining the station. In some embodiments, each network station is a closed or private station at least partially controlled by a particular entity and only accessible to consumers visiting the station, and optionally, to the entity's trusted affiliates.

Certain embodiments described herein also address problems with vendor discovery that exist with previously available vendor discovery applications. Not all reviews are created equal; when searching for a vendor, consumers often want to find a vendor not yet known to others in their network, but they also want to find a vendor recommended by a trusted authority and/or by others who are identified as sharing common tastes, lifestyle choices, or affiliations. Accordingly, some embodiments described herein improve vendor discovery and content dissemination by intelligently filtering content and vendor recommendations for each consumer.

For example, in some embodiments, consumers may be able to create user profiles, pull in personalization information from user profiles they have created on third party systems, and/or set content preference filters; additionally or alternatively, the application supporting the digital network may be able to record and store consumers' browsing and location histories in order to fine-tune the types of invitations and offers the consumers receive and/or to fine-tune the listing of recommended trusted affiliates displayed to them. In some such embodiments, promotional and other commercial content can be carefully and finely tailored to be displayed only to consumers identified as having a high likelihood of finding such content valuable.

One aspect of the disclosure is directed towards a computer-implemented method of receiving content. In some embodiments, the method can include one or more of transmitting location data to an application server, receiving data identifying one or more available network stations from the application server, displaying the one or more available network stations to a user, receiving a network station selection from the user, transmitting the network station selection to the application server, connecting to the selected network station, accessing content available on the selected network station, and displaying content available on the selected network station to the user. In some embodiments, the one or more available network stations can be identified, for example, based on, at least in part, the transmitted location data and/or transmitted venue characteristic data.

Some embodiments further may include one or more of receiving content preference data from the user, transmitting content preference data to the application server, and receiving an offer, invitation, or other content from the application server. In some embodiments, the offer or other content can be generated by a partner venue or a trusted affiliate vendor or pulled from a daily deal provider, and screened and selected for the user. In some embodiments, the offer may be selected by the network station or the application server. In some embodiments, the offer may be selected based, at least in part, on the user's selected network station and the transmitted content preference data.

Another aspect of the disclosure is directed to a computer-implemented method of delivering content to consumers. In some embodiments, the method may include receiving content preferences from a consumer computing device. For example, in some embodiments, the content preferences are selected by a consumer interfacing with the consumer computing device. In other embodiments, the content preferences may be determined based on interests or other biographical information listed in a consumer's profile saved within the system or pulled from a third-party system. The method of some embodiments further may include receiving location data from the consumer computing device, and connecting the consumer computing device to a network station selected based, at least in part, on the location data.

In some embodiments, the network station may be at least partially controlled by a venue or other entity. In some such embodiments, the method further includes receiving content from a trusted affiliate, wherein the trusted affiliate has been granted access to the network station by the venue or other entity. The method may further include determining whether to disseminate the content from the trusted affiliate to the consumer computing device. The determination, in various embodiments, is based on the content preferences received from the consumer computing device.

In some embodiments, the method further may include transmitting the content to the consumer computing device. In some such embodiments, transmitting the content to the consumer computing device can involve transmitting a commercial offer to the consumer computing device via email, SMS text, push notifications, or through an application interface, for example. In various embodiments, the consumer computing device may be or include, one or more of a smartphone, tablet, in-vehicle computer, wearable computing device, or other network-connected computing device.

Additionally or alternatively, in some embodiments, the method can include identifying one or more entities in proximity to the consumer computing device, transmitting data identifying one or more available network stations associated with the one or more entities to the consumer computing device, and receiving a network station selection from the consumer via the consumer computing device. The network station may be selected from the one or more available network stations. In some such embodiments, connecting the consumer computing device to a network station involves granting the consumer computing device access to the network station selected by the consumer, with or without authorization.

In another aspect of the disclosure, the technology is directed to a computer-implemented method of distributing content to a user of a computer application. In various embodiments, the method includes transmitting location data to a remote computer, and receiving identification data from the remote computer identifying one or more available network stations, wherein at least some, or each, of the one or more available network stations are or is created or sponsored by a different partner entity, and wherein the one or more available network stations are identified at least by a name and location of the respective partner entity. The method of some embodiments further includes: displaying the identification data of the one or more available network stations to a user; receiving a network station selection from the user, the network station having been created or sponsored by a particular partner entity; transmitting the network station selection to the remote computer; connecting to the selected network station, wherein the selected network station comprises content created or approved by the particular partner entity; receiving a filtered portion of the content created or approved by the particular partner entity, wherein the filtered portion comprises content determined to be relevant to the user based, at least in part, on the user's location data or content preference data; and displaying the filtered portion of the content to the user.

In yet another aspect of the disclosure, the technology is directed to a mobile computing device comprising a processor configured to perform a method of distributing content to a user of a computer application. In some embodiments, the processor is configured to perform one or more of the methods described above.

Another aspect of the disclosure is directed to a non-transitory machine-readable storage medium embodying a set of instructions that, when executed by a processor, cause the processor to perform operations or methods, such as, for example, a method of distributing content to a user of a computer application. In some embodiments, the instructions cause the processor to perform one or more of the methods described above.

Another aspect of the disclosure is directed to a system of stations or micro-applications accessible to a user via a single mobile application, wherein each station comprises unique content curated by a partner entity, the partner entity comprising a venue, organization, or individual who created or sponsors the station. In certain embodiments, the station content is stored in one or more remote computing devices, such as, for example, one or more application and/or database servers. In various embodiments of the system, a user accessing a particular station within the single mobile application is provided, on his or her mobile computing device, a filtered portion of the curated content available within the station. The content is filtered for a user based on, for example, the user's location, location history, application activity history, user profile, and/or content preferences. Such data used to filter content may be generated by the user (i.e., the consumer) and/or the user's mobile computing device and is transmitted from the user's mobile computing device to the one or more servers or other remote computing devices for storage and processing. The user's application activity history may comprise data concerning content the user has interacted with in the past and/or ratings, markings, or reviews generated by the user in the past. In various embodiments, one or more of the user's: location, location history, application activity history, user profile, and content preferences are accessible across stations within the system, such that the system generates a detailed collection of data about the user.

These are just some of the system's potential features and functions. The foregoing is a summary and thus contains, by necessity, simplifications, generalizations, and omissions of detail; consequently, those skilled in the art will appreciate that the summary is illustrative only and is not intended to be in any way limiting. Any particular system may have some or all of these features or additional or alternative features. Other aspects, features, and advantages of the systems, methods, devices, and/or processes described herein will become apparent in the teachings that follow.

### BRIEF DESCRIPTION OF THE DRAWINGS

The above-mentioned aspects, as well as other features, aspects, and advantages of the present technology will now be described in connection with various embodiments, with reference to the accompanying drawings. The illustrated embodiments, however, are merely examples and are not intended to be limiting.

FIG. 1 is a schematic block diagram of one embodiment of a content delivery ecosystem, which depicts network stations, network participants, and interactions between the participants and the stations.

FIG. 2 is a schematic block diagram of one embodiment of an application server.

FIG. 3 is a functional block diagram of one embodiment of a content delivery ecosystem.

FIG. 4 is a flowchart illustrating an embodiment of a method for receiving content from a network.

FIG. 5 is a flowchart illustrating one embodiment of a method for delivering content to consumers.

FIGS. 6A-6L represent some examples of user interface screens provided within one embodiment of a content delivery ecosystem.

### DETAILED DESCRIPTION OF CERTAIN EMBODIMENTS

In the following detailed description, reference is made to the accompanying drawings, which form a part of the present disclosure. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein and illustrated in the Figures, can be arranged, substituted, combined, and designed in a wide variety of different configurations, all of which are explicitly contemplated and form part of this disclosure. For example, a system or apparatus may be implemented or a method may be practiced using any number of the aspects set forth herein. In addition, such a system or apparatus may be implemented or such a method may be practiced using other structure, functionality, or structure and functionality in addition to, or other than, one or more of the aspects set forth herein.

### Introduction

The systems and methods described herein relate to a global network of local and/or hyper-local network stations created, sponsored, and/or managed by numerous kinds of entities to which a person may travel, including, for example: venues, such as, for example, hotels, resorts, amusement parks, cruise ships, shopping malls, college and corporate campuses, concert halls, sports arenas, theaters, and other entertainment venues, schools, museums, convention centers, airports, and other facilities; and events, such as, music festivals, sports competitions, trade shows, professional conferences, and the like.

In some embodiments, an entity must receive approval or an invitation from a network administrator in order to establish a station within the network. As used herein, the term “partner entity” refers to any entity that has been provided access to the network and has created or sponsored a network station.

As used herein, a station that is “created or sponsored” by a partner entity refers to a station built by or for a partner entity. Such a station is designed to present content generated or approved by the partner entity. In some embodiments, partner entities use APIs and developer tools to build their own stations within the digital network. In some embodiments, an application/network administrator develops network stations on behalf of partner entities. In such embodiments, the partner entities then add, edit, or approve content for display within their respective stations.

In various embodiments, the digital network of stations is accessible via a single mobile or internet application, enabling partner entities to create unique mobile experiences for their respective consumers without needing to build and promote their own individual mobile applications. Through its station, a partner entity can act as local travel guide and concierge, providing recommendations to station visitors, for example, dining, shopping, and activity recommendations; the partner entity can also connect its station's visitors to local deals. The digital network enables every consumer to feel like a local regardless of location by providing a system through which consumers can find and connect to local partner entity stations matching their tastes, interests, and/or affiliations. By connecting to the station of a local partner entity, a consumer can access the concierge-like recommendations, deals, and other “insider” content provided on the station.

Advantageously, in various embodiments, the digital network enables partner entities to shape their brands. By selecting local vendors to recommend and by generating other content, partner entities can control the look and feel of the user experience within their respective stations. Additionally, the network provides local vendors with effective advertising channels, enabling the vendors to target, and be discovered by, consumers likely to be interested in transacting with the vendor.

In various embodiments, the network stations created or sponsored by partner entities are designed to strategically disseminate information to consumers who are identified, based at least in part, on their location, as likely receptive to the information. In some embodiments, the system is contextually aware and further filters the information disseminated to consumers based on other information, such as, for example, a consumer's stored location history, browsing history, interests, purpose of travel, affiliations, and/or biographical data, and/or environmental data such as the time of day, day of the week, the season, the weather, etc.

In some embodiments, a consumer may additionally or alternatively be able to explore a locality such as a city, region, or neighborhood within the single application without entering or connecting to a partner entity's micro-application or station. For example, information about all vendors recommended by partner entities, as well as information about other vendors, may be aggregated by the application and available for viewing by a consumer within a list or map format in the application. In some such embodiments, the application includes features designed to curate vendor data in order to give each consumer a concierge-like experience that enables the consumer to feel like an insider even when the consumer is not signed in to a particular partner entity station.

For example, the application may prompt the consumer to select one or more “lenses” through which the consumer wishes to view the locality. As used herein, a lens is a consumer-selected filter used to narrow the universe of vendors, deals, and other content available for a consumer to explore within the application. Each of the filters may represent a taste, interest, lifestyle choice, belief, passion, and/or affiliation of the consumer. Non-limiting examples of lenses include: memberships, for example, memberships to organizations such as fitness clubs, recreational sports leagues, local auto clubs, chambers of commerce, civic organizations, neighborhood groups, places of worship, and the like; rewards/loyalty programs, such as hotel rewards programs, airline loyalty programs, etc.; causes a consumer may care about, such as fair trade, human rights, humane treatment of animals, green/environmentally friendly practices, etc.; special diet/health, such as vegan, dairy-free, or gluten-free; special interest, foodie, award winning, or other. In some embodiments, upon selecting a lens, the vendors displayed or suggested to the consumer may be filtered to include only those affiliated with, endorsed by, or recommended by a representative of the lens. For example, if a consumer activates the AARP lens then searches for vendors in a locality, only those vendors who offer AARP discounts may be displayed. In another non-limiting example, if a consumer activates a gluten-free lens, only vendors recognized by, for example, the Celiac Disease Foundation or a local gluten-free blogger, as providing gluten-free offerings will be listed. The categorization of vendors into appropriate lenses may be performed by official representatives of the respective lenses, by an administrator of the application, and/or by approved individuals, such as, for example, local celebrities, radio personalities, and local bloggers.

In some embodiments, the system, which forms the global network, includes: a web or mobile interface through which consumers can access a plurality of stations; an interface that allows each partner entity to create (or have created on its behalf) a network station, and which further allows each partner entity to generate, customize, and curate the information available on the station; and a backend subsystem formed of database servers, application servers, and/or web servers, which operate to store consumer-created content such as profile information, partner entity-created content, vendor-created content, and data related to consumers' location histories, station visits, and application usage. In some embodiments, the system further includes an interface that allows each vendor to create (or have created on its behalf): a page of information about the vendor, and/or deals, invitations, or special offers. The vendor interface may also include tools for vendors to communicate with entities to request affiliate with said entities and/or to deliver deals or other content to partner entities for display within the partner entity stations.

In some embodiments, a uniform template is available for partner entities to utilize when creating their network stations. The template of some embodiments enables even those without computer programming experience to create a partner entity station. Unique text, differentiated graphics, music, photographs, and/or video can be added into the template in order for each partner entity to customize and personalize its network station.

In some embodiments, a backend API layer with a suite of developer tools is also available for those who wish to create a more customized experience. By customizing the template and/or using API tools, each partner entity can tailor its respective station to convey a particular personality or brand. In some embodiments, the backend API layer includes tools for integrating various commerce, content, review/ratings, and transaction systems into a network station. Additionally, in some embodiments, each partner entity is able to distribute messages, invitations, and commercial offers to consumers connected to its particular station. In some embodiments, such content may be distributed by posting it as an advertisement viewable by all within the station, by posting it as a location-based advertisement viewable to all station-connected consumers at or near a particular location, or by sending it as a message (email, text, push notification, or otherwise) to one, some, or all consumers connected to the network station. In some embodiments, the partner entity can identify the message, invitation, or commercial offer as one it would like to disseminate to at least some of its connected consumers; the partner entity or application/network administrator may then categorize the content, and the content may be distributed as a posting or a message to select station-connected consumers who match certain characteristics corresponding to particular content categories. As a non-limiting example, the partner entity may create a category of content called “bar specials,” which may only be provided to station-connected consumers who match the characteristic of being 21 years of age or older. In some embodiments, each partner entity is also able to invite trusted affiliates to utilize the entity's network station to reach connected consumers through some or all of the communication channels described above.

Additionally or alternatively, in some embodiments, a uniform template may be available for each vendor to utilize to create a vendor page. As with the partner entity template, the template is user-friendly, and unique text, differentiated graphics, music, photographs, and/or video may be added into the template in order for each vendor to customize and personalize its page. Alternatively, each vendor page may be created by an application/network administrator, at least in part by pulling and organizing information from third-party sites such as Yelp® and Foursquare®. In various embodiments, a tool may be available within the vendor-facing interface, which allows each vendor to create and disseminate offers, invitations, and/or deals.

The system of some embodiments also includes a front-end application available for use on smartphones, tablets, in-vehicle computers, smart watches and other wearable mobile devices, and other network-connected computing devices. The application connects consumers to a global network from which each consumer can connect to one or more local stations in range. Once connected, consumers have the ability to view content, engage in commerce, and in some embodiments, communicate with other people connected to a particular station or the global network.

In some embodiments, the front-end application has a personalization layer. Within the personalization layer, consumers may be able to create one or more user profiles. For example, in some embodiments, one consumer can create multiple profiles, such as a work profile and a personal-life profile. Within the profiles of some embodiments, consumers can select interests from pre-defined categories of interest and provide biographical information such as, for example, age, gender, sexual orientation, income level, marital status, highest level of education attained, etc. In some embodiments, consumers can alternatively or additionally link to personal profiles they maintain on third-party systems (such as, for example, Facebook, Twitter, or LinkedIn) and/or pull information from such profiles. In some embodiments, consumers can also use the personalization layer to set personal preferences in order to filter and regulate the kinds of messages, the frequency of messages, and the form of messages they receive. Consumers can also use the personalization layer of some embodiments to activate one or more viewing lenses of interest to them. A consumer may also be able to create lists of favorite vendors. Such lists may be categorized and personalized; as a non-limiting example, a consumer who loves to go out to eat may create lists of favorite restaurants, favorite sushi restaurants, favorite restaurants for a cheap date, and favorite restaurants in Los Angeles. In some embodiments, these lists can be shared with others in a consumer's network or other application users located nearby. Additionally or alternatively, a consumer may receive a notification whenever a vendor on one of his or her lists has a new association, deal, offer, or event related to an activated lens of the consumer. The user profile information and selected personal preferences may stay in effect across partner stations and when a consumer is exploring the application without connecting to a particular partner station. In some embodiments, the user profile information and personal preferences can be further modified by a consumer within each station.

In some embodiments, the system is configured to facilitate communication between people and the discovery of new people and/or places. In some embodiments, consumers can communicate with other consumers in the same network station, for example, through a message board, chat room, micro-blogging forum, private chat, or other collaborative interaction feature provided in the station. In some embodiments, a consumer may also be able to select other consumers as contacts, save these contacts, and communicate with these contacts regardless of which, if any, network station they are connected. Communications between contacts may occur, for example, through a group chat, private group micro-blogging forum, private chat, email, or text feature. In some embodiments, consumers may be able to view the user profiles of their contacts, see to which network station a particular contact is connected, and/or view content created by a contact. Additionally or alternatively, consumers may be able to view the locations or relative proximities of their contacts via various technologies, including for example, GPS, Wi-Fi networks, Bluetooth networks, and/or low energy Bluetooth sensor beacons. In some embodiments, a consumer is alerted when a saved contact is detected as being nearby, such as within a particular distance range. In various embodiments, consumers may be able to form digital social networks with their contacts and others in the global network. In some embodiments, consumers may be able to create lists and make them accessible to anyone connected to the application or share them privately with selected contacts.

Additionally or alternatively, in some embodiments, the system includes a global (i.e., station-agnostic) activity feed displayed within the front-end application. The activity feed may further facilitate communication between people and the discovery of new people and/or places by presenting a consumer with information about contacts, lenses, stations, and vendors of interest to them. For example, the activity feed may indicate that a contact has activated a lens or tuned into a station, or an activated lens has added a new vendor to its list of certified vendors, etc. The activity feed will present information to a consumer based on the activity of: the consumer's contacts, the consumer's activated lenses, and optionally, stations recently visited by the consumer.

In some embodiments, the system disclosed herein integrates with other location-based systems and applications, such as, for example, Foursquare®, Yelp®, or other applications with a check-in feature, so that station-connected consumers may identify other consumers at a particular location, even if the other consumers do not yet have the front-end application described herein. In such embodiments, connected consumers may be able to use the provided front-end application to send an email, text, or other message to unconnected consumers inviting them to use the application and join the network station.

In some embodiments, the system may recommend potential contacts to a consumer. For example, in some embodiments, the system can identify consumers who have connected to several of the same or similar network stations and/or have selected at least some of the same lenses and recommend that these consumers connect to each other. Additionally or alternatively, the system can identify consumers currently connected to the same network station who have similar information in their profiles and suggest that these consumers connect together. Additionally or alternatively, the system can identify consumers in proximity to each other via GPS, WiFi networks, low energy Bluetooth networks, or beacon technology built into their mobile computing devices, and suggest that these consumers connect together.

In some embodiments, connected consumers can rate, mark as a “like”, “dislike”, or “favorite”, and/or review partner entities. Consumers may also be able to rate, mark, or review various services, sub-entities, amenities, and events offered by a partner entity. In some embodiments, consumers may also rate, mark, or review the various vendors recommended by the partner entity (i.e., the trusted affiliates). In some such embodiments, these ratings and reviews are viewable by anyone within the global network. In other embodiments, the ratings and reviews are viewable to anyone connected to the station where the review occurred. In certain embodiments, the partner entity provides a description or reasoning of support for each trusted affiliate they recommend. In some such embodiments, functionality built into the station allows for social validation of the partner entity's recommendations. For example, in some embodiments, information, ratings, and/or reviews from third party applications such as Yelp® or Foursquare® are integrated into the station and visible along with each of the partner entity's recommendations.

In various embodiments, the network stations can be viewed as substantially closed or private sub-networks. In certain embodiments, in order to access a particular station, a vendor must receive permission from the partner entity operating the network station and/or from an application administrator. Additionally, in order for a consumer to access the station, the consumer must at least have the front-end application loaded on a computing device. In some embodiments, the consumer must also be located within the location of the partner entity and/or enter credentials (such as for example, a hotel room number and last name on a hotel reservation) to demonstrate that they have permission to be within the location of the partner entity. In certain other embodiments, the consumer must be located near a partner entity in order to access the partner entity's station. In still other embodiments, a consumer connected to the global network can access some or all stations by entering in addresses or names of partner entities of interest or by browsing and selecting a partner entity from a list or map of partner entities.

In some embodiments, the network also includes digital screen nodes that advertise the presence of the network and available network stations. The digital screens may showcase activity and content that is happening in real-time across the global network or on a particular network station. For example, in various embodiments, the content and activity within a station is displayed on the computing device screens of the various consumers connected to a particular station. The content and activity within a network station may also be displayed on large display screens in or near the location of a partner entity. In some embodiments, a partner entity may use one or more digital screen nodes, for example, to advertise the presence of its network station, to showcase commercial advertisements offered by the partner entity or its trusted affiliates, and/or to highlight the consumers who are already connected to the network station.

### System Overview

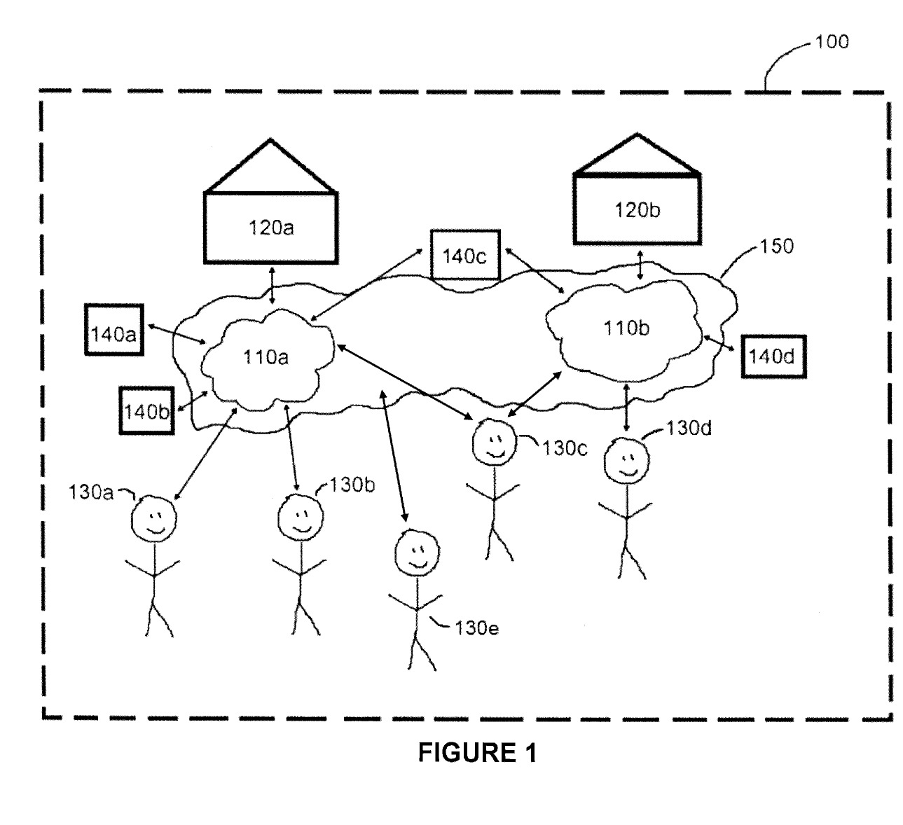

FIG. 1 is a schematic diagram of one embodiment of a content delivery ecosystem. The content delivery ecosystem 100 is formed of various partner entities 120a, 120b, consumers 130a, 130b, 130c, 130d, and trusted affiliates 140a, 140b, 140c, 140d selectively sharing content within a global network 150 via network stations 110a, 110b. While only a few network stations 110, partner entities 120, consumers 130, and trusted affiliates 140 are depicted, it should be appreciated that such a depiction is for ease of illustration only. In some embodiments, a large plurality of network stations 110, partner entities 120, consumers 130, and trusted affiliates 140 are present in the content delivery ecosystem 100. For example, the content delivery ecosystem 100 may include tens, hundreds, thousands or more partner entities 120 each having its own network station 110. The content delivery ecosystem 100 may also include tens, hundreds, thousands or more trusted affiliates 140, each connected to one or more of the network stations 110. At any time, tens, hundreds, thousands, millions, or more consumers 130 may be connected to one or more network stations 110 within the global network 150. Additionally, in some embodiments, at any time, tens, hundreds, thousands, millions, or more consumers 130 may be connected to the global network 150 without being actively connected to any network station 110.

As depicted by the two-way arrows in FIG. 1, in some embodiments, the various network participants are each able to receive content from a network station 110 and provide content to the network station 110. In other simpler embodiments (not shown), the partner entities 120 alone, or the partner entities 120 and trusted affiliates 140, may be the only participants capable of providing content to the network station 110, and the consumers 130 may be capable of receiving content only. In various embodiments, communication between a network station 110 and any of the participants occurs over a wireless communication network, such as, for example, over a mobile WiMAX network, LTE network, Wi-Fi network, a network of low-energy Bluetooth signals generated by sensor beacons, or other wireless network.

Each partner entity 120 either creates its own network station 110, similar to a website, with the aid of templates and/or API tools or has such a station 110 created on the partner entity's behalf. In some embodiments, a network station 110 is available for passive consumption by consumers 130; that is, the network station 110 provides content, which consumers 130 can read, watch, or otherwise consume.

In preferred embodiments, a network station 110 provides dynamic content available for active consumption; that is, consumers 130 can both consume content and generate new content. For example, in some embodiments, at least some network stations, such as network stations maintained by hotels and resorts, include a digital check-in/check-out system through which consumers 130 can check into or out of a partner entity. As an additional example, in some embodiments, a network station 110 includes transactional systems through which consumers 130 can order goods and/or services. Consumers 130 may be able to select the goods and/or services of interest and provide payment information to transact business through the network station. In some embodiments, the payment information is stored within a consumer's profile so that transactions can occur without needing to supply this information each time. Some of or all the information entered by a consumer 130 may be available for review by the partner entity 120 or one or more trusted affiliates 140. In certain embodiments, some or all network stations 110 include functionality for consumers 130 to securely and seamlessly communicate with third party payment vendors to handle payment processing of commercial transactions; for example, in some embodiments, stations 110 each include a third party payment API supported by a service such as Square®, Google Wallet®, V.me by Visa®, PayPal®, or Dwolla®.

Additionally or alternatively, in certain embodiments, some or all network stations 110 include functionality for consumers 130 to interface with additional third party APIs to integrate additional features into the stations 110. For example, in some embodiments, an API is provided to integrate some or all stations 110 with Yelp®, Foursquare®, and/or other location-based vendor aggregation and review application. Such an integration may allow consumers to post reviews and view other reviews, hours of operation, user tips, a relative costliness rating, and/or other available information pertaining to a trusted affiliate or other local vendor. In some additional or alternate embodiments, an API is provided to integrate some or all stations 110 with OpenTable®, Fandango®, Ticketmaster®, and/or other online reservation application to allow consumers to reserve a space at restaurants, movie theaters, entertainment venues, and/or other trusted affiliates or other local vendors.

In some embodiments, some of or all the partner entities 120 may provide loyalty programs through the stations 110 they create. In such embodiments, consumers 130 may receive credits or points towards a partner entity's loyalty program upon connecting to the partner entity's station 110. If the partner entity 110 is part of a chain, for example, a hotel within a hotel chain, a consumer 130 who connects to the partner entity's network station 110 may receive credits or points towards the chain's loyalty program. This loyalty program may be a loyalty program unique to the global network or it may be part of an established loyalty program offered by the partner entity or related chain.

Additionally or alternatively, in some embodiments, a network station 110 includes one or more collaborative interaction features, such as, for example, a pinboard, bulletin board, or other message board, a file-sharing system, a chat room, a private messaging service, or a micro-blog forum (similar, for example, to Twitter), through which consumers 130 can receive content and contribute new content. Through the messaging system, a consumer 130 may post content available for viewing by all participants connected to a network station 110, or the consumer 130 may exchange information with a select group of one or more other consumers 130, one or more trusted affiliates 140, or the partner entity 120.

In some embodiments of the content delivery ecosystem 100, the global network 150 is configured such that a consumer 130 is capable of being connected to only one network station 110 at any given time. In other embodiments, such as, for example, the embodiment shown in FIG. 1, a consumer 130, such as consumer 130c, may be connected to more than one local or hyper-local network station 110 at a time. As one non-limiting example, a consumer 130c may be staying at a resort within a city and attending a professional convention within the convention hall on the resort grounds. In such an example, in some embodiments, the consumer 130c may be connected to a network station 110a for the resort, another network station 110b for the convention hall, and another network station (not shown) maintained by the city. In the provided example, the content available on the resort's network station may be directed primarily to the amenities and facilities available at the resort; the content available on the convention hall's network station may be tailored for the professional convention being held, and the content available on the city's network station may highlight great things to see and do within the city.

In some embodiments, the global network 150 may provide a game-like feature in which consumers 130 are rewarded for using and interacting with the system. For example, consumers 130 may receive points, credits, or other rewards when they perform functions such as: connect to a network station 110, post content to the network station 110, watch an advertisement on the network station 110 posted by a trusted affiliate 140, perform a commercial transaction on a network station 110, rate or review a partner entity 120 or trusted affiliate 140, or invite another consumer to join the global network 150. In some embodiments, the rewards have non-economic value, for example, earning a consumer bragging rights, a particular status or title within the global network 150, and/or a special badge or icon. Additionally or alternatively, in some embodiments, the rewards may have economic value and may be redeemable with partner entities 120 and/or trusted affiliates 140 within the global network 150. As a non-limiting example, the points, credits, or other rewards may be redeemable for discounted goods or services at a trusted affiliate (such as 10% off at a clothing store or a free dessert at a restaurant).

As mentioned above, in some embodiments, a consumer 130e may be connected to the global network 150 without being connected to a network station. In some such embodiments, the consumer 130e may create or update a user profile, browse a newsfeed, create, edit, or view lists, and/or search for or browse through vendors based on location and personalization data, such as activated lenses, saved within the consumer's user profile.

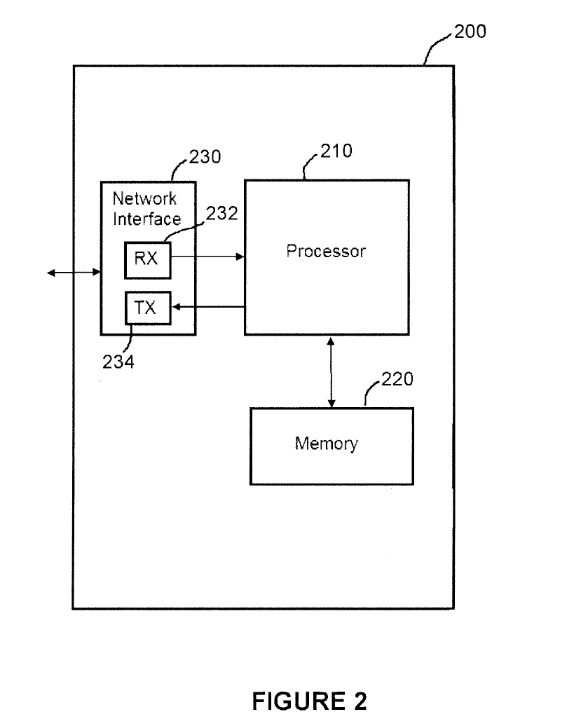

The global network 150 of some embodiments is formed of one or more servers operated by a network administrator. FIG. 2 provides a functional block diagram of one embodiment of such a server 200. In some embodiments, the server 200 includes, at least, a processor 210 in data communication with a memory 220 and a network interface 230. Although described separately, it is to be appreciated that functional blocks described with respect to the server 200 need not be separate structural elements. For example, the processor 210 and memory 220 may be embodied in a single chip. Similarly, the processor 210 and network interface 230 may be embodied in a single chip. Likewise, the receiver 232 and transmitter 234 of the network interface 230 may be embodied in a single chip.

The processor 210 can be a general purpose processor, a digital signal processor (DSP), an application specific integrated circuit (ASIC), a field programmable gate array (FPGA) or other programmable logic device, discrete gate or transistor logic, discrete hardware components, or any suitable combination thereof designed to perform the functions described herein. A processor may also be implemented as a combination of computing devices, e.g., a combination of a DSP and a microprocessor, a plurality of microprocessors, one or more microprocessors in conjunction with a DSP core, or any other such configuration.

In some embodiments, the processor 210 is coupled, via one or more buses, to read information from, or write information to, the memory 220. Additionally or alternatively, the processor 210 may itself contain memory 220, such as processor registers. The memory 220 can include processor cache, including a multi-level hierarchical cache in which different levels have different capacities and access speeds. The memory 220 can also include random access memory (RAM), other volatile storage devices, or non-volatile storage devices. The storage devices can include, for example, hard drives, optical discs, such as compact discs (CDs) or digital video discs (DVDs), flash memory, floppy discs, magnetic tape, and Zip drives.

In some embodiments, the processor 210, in conjunction with software stored in the memory 220, executes an operating system, such as, for example, Windows, Mac OS, Unix, or Solaris. The processor 210 also executes software applications stored in the memory 220. The software can be programmed in any suitable programming language known to those skilled in the art, including, for example, C++, Ruby, PHP, or Java. In various embodiments, the memory 220 includes software such as, for example, web server software provided by Apache or Tomcat, to facilitate operation of the server 200 as a web server.

The processor 210 of various embodiments is further coupled to a network interface 230, including a receiver 232 and a transmitter 234. The transmitter 234, in conjunction with the network interface 230, prepares data generated by the processor 210 for transmission over a communication network according to one or more network standards. The receiver 232, in conjunction with the network interface 230, demodulates data received over a communication network according to one or more network standards. For example, in one non-limiting example, data is received by the receiver 232 and transmitted by the transmitter 234 over a mobile WiMAX network, LTE network, Wi-Fi network, or other wireless network. In some embodiments, the transmitter 234 and the receiver 232 are part of the same component, such as, for example, a transceiver. In other embodiments, the transmitter 234 and receiver 232 are two separate components.

In some embodiments, the server 200 stores templates and an API library and tools for various partner entities to use to generate content. A network administrator oversees the global network and receives requests or extends invitations to various entities it wishes to include within its network. When an entity joins the network, becoming a partner entity, it is able to access tools stored within the server 200 to create content. Moreover, once an entity, vendor, and/or consumer generates content, it can store the content within a location (physical or transient) in the server 200.

### Example System

Provided herein is one non-limiting example, described with reference to FIG. 1, and included to showcase the interactions between the various network participants within the content delivery ecosystem 100. When consumers open the front-end application, they may be routed directly to content available on the network station or they may first go to a main page, for example, a home page of the application, which is maintained by the administrator of the global network. On the global network's page, consumers may be able to update a user profile, send invitations to other consumers to become contacts, monitor the activity of their current contacts, communicate with their contacts, rate or review partner entities whose network stations they have previously visited or partner affiliates they have visited, view a list and/or map of network stations to identify one to enter, or select lenses to activate or deactivate.

In the example, the partner entity 120a is an upscale resort, such as the Four Seasons®. The resort wishes to create a network station 110a that is fitting of its brand and appealing to its clientele. Upon receiving approval from the network administrator, the resort may access templates to create pages of information. The graphics, background, and/or fonts may be carefully selected to create a refined look. Content posted by the resort may include, for example, a map of the resort's grounds, the upcoming weather forecast, photographs and videos highlighting the resort's amenities, the menus and hours of operations of the onsite restaurants, the hours of operations of the pools and exercise facilities, the schedule of onsite entertainment and activities, the spa offerings and hours of operation, and a listing of recommended things to see and do near the resort. The partner entity (e.g., the resort) and/or the network administrator may also choose to post advertisements within the network station.

An API layer may also be integrated into the resort's network station 110a, allowing connected consumers 130a, 130b, 130c to perform tasks such as checking in, checking out, reserving a cabana, booking an appointment at the spa, making a dinner reservation, scheduling a wake-up call, or ordering room service. Additional tools within the API layer may allow connected consumers to rate or review the resort itself, along with the resort's pools, shops, restaurants, hotel services, and evening activities. Tools may also be provided for consumers to rate, review, and/or view third-party ratings and reviews of vendors and activities included in the resort's listing of recommended things to see and do near the resort (i.e., trusted affiliates). The ratings and reviews may be viewable by the resort and by other consumers connected to the network station 110a, and optionally, by other consumers connected to the global network 150. More tools within the API layer may link the resort's network station to the resort chain's (e.g., the Four Seasons's) loyalty program. Upon connecting to the resort's network station, a consumer's account within a loyalty program may automatically be updated. Consumers may also be able to check the status of their loyalty program account through the network station.

The network station 110a may also include a message board, chat room, micro-blogging forum, and/or private chat functions, through which guests at the resort can interact with one another or with resort staff. For example, a connected consumer 130a may post a message to the message board or micro-blogging forum looking for a tennis partner. Various resort guests who see the message may choose to view the user profile of the connected consumer 130a when deciding whether to volunteer to be a tennis partner. Once a potential tennis partner responds, the connected consumers 130a, 130b may utilize the private chat feature of the network station 110a to discuss the logistics of the tennis match. The connected consumer 130a may also correspond with the resort's concierge directly through the network station 110a, for example, to reserve a court time. The connected consumers 130a, 130b may also choose to save each other as contacts, allowing them to easily connect in the future, and optionally, allowing each to view other network stations to which the other connects.

Moreover, the partner venue 120a may invite or accept requests from one or more vendors to become trusted affiliates 140a, 140b, 140c. For example, the upscale resort may select the local Prada store, Saks Fifth Avenue, Capital Grille, and a reputable helicopter tour guide to each be a trusted affiliate 140. The resort may identify these trusted affiliates as “local recommendations,” or the like. The local recommendations may be listed under particular categories, such as, for example, recommended shopping, dining, and activities. While only four local recommendations are provided here, in some embodiments, a partner entity such as the resort may provide dozens or hundreds of local recommendations. In some embodiments, only a portion of these local recommendations are viewable to any particular consumer (e.g., resort guest), based, for example, on the consumer's location and/or identified personal preferences or lenses. In some embodiments, the resort concierge or other resort personnel tasked with creating content for the station may include a description with each local recommendation, indicating, for example, why the resort recommends the trusted affiliate. Such recommendations may be accompanied by social validation features such as information, ratings, and reviews from third-party applications.

In some embodiments, consumers such as, for example, resort guests, may be able to turn on various lenses to further filter and distill the listing of local recommendations visible to them within a network station. As described in more detail above, a lens is an additional filter selected by a consumer from an available list of filters that narrows the content provided to the consumer based, for example, on the consumer's tastes, interests, and/or affiliations. Lenses may be used to filter content inside and outside of partner entity stations. For example, while connected to the resort's station, a resort guest may be able to turn on a AAA® filter to limit the resort's listing of local recommendations to those that offer a discount to AAA® members. Similarly, a resort guest may be able to turn on a MasterCard® filter to limit the resort's listing of local recommendations to those that offer cash back bonuses on MasterCard® transactions. As another example, a resort guest may be able to turn on a lens for PETA to limit the resort's listing of local recommendations to those that follow PETA guidelines for the ethical treatment of animals. Another resort guest may choose to turn on a “vegan” lens created by a local blogger who identified all nearby restaurants offering a vegan menu or vegan options. Turning on such a lens will limit the resort's listing of local recommended dining options to those that are also found on the local blogger's vegan list.

Both the resort and the trusted affiliates may generate commercial offers and invitations that are of value to some of the resort's clientele. For example, the resort's spa may offer a two-for-the-price-of-one couple's message. The Capital Grille may offer a 10 oz. filet for the price of their 8 oz. filet. Prada may offer an invitation to an after-hours preview of the new fall merchandise. The helicopter tour guide may offer a tour not generally offered to the public such as a helicopter tour and charter to local vineyards. These offers and invitations may be generated as emails, text messages, or push notifications, or show up as alerts within the application. In some embodiments, the resort, the trusted affiliates, or a network administrator may control when the commercial offers and invitations are displayed. For example, in some embodiments, the content is provided to every resort guest connected to the resort's station, or every resort guest with matching content preference data (as described in more detail in the next paragraph). In other embodiments, the content delivery is location-based; for example, the Prada offer may be provided to resort guests located within the local shopping district, and the helicopter tour may be provided to all guests who enter the resort's wine bar.

In some embodiments, the consumer 130 is able to input content preference data indicating which types of offers they wish to receive, such as, for example, offers for shopping, dining, spa services, family activities and/or romantic activities. In some embodiments, the consumer 130 is additionally or alternatively able to input interests and other biographical information into a user profile or pull such information from user profiles maintained on third-party systems. For example, the consumer 130a may link to, or pull information from, her Facebook profile in which she lists food and wine as interests. In such a scenario, a filter in the network station or elsewhere in the ecosystem (for example, a filter in the network server) will identify which offers are appropriate to send to consumer 130a, distributing the Capital Grille offer to her. The consumer 130b may have created two user profiles using the front-end application—one for business and one for pleasure. Upon connecting to the resort's network station 110a, the consumer 130b may have selected to use the personal/pleasure profile. If, for example, in the consumer's personal profile, consumer 130b had selected content preference boxes indicating that he only wishes to receive information about men's clothing and adventure activities, the filter would distribute only the Prada invitation and helicopter offer to consumer 130b. In order to deliver targeted content to each resort guest 130, the resort, the trusted affiliates, or a network administrator may categorize each offer, associating each offer with one or more category tags, for example, by tagging the helicopter ride as an adventure activity, a romantic activity, and an activity with alcohol, so that the servers and/or application automatically provide the content to the appropriate guests.

In some embodiments, offers and/or local recommendations may additionally or alternatively be filtered based on environmental data such as the time of day, day of the week, the season, or the weather. As one example, while the helicopter tour and charter to local vineyards may be an ongoing offer available to the resort's guests, the offer may not be displayed to guests during the winter or when bad weather is in the forecast all week. As another example, the Capital Grille offer may be displayed between 3 pm and 7 pm, during the hours when guests are contemplating where they would like to go for dinner.

In certain embodiments, guests may set, for example, within their personal profiles or a personal settings feature, how frequently they wish to receive offers and other information from the station and in what form. For example, guests may be able to specify a frequency such as: as soon as the content is available, once an hour, once a day, etc. Additionally, guests may be able to specify whether they wish to receive the content via email, text messaging, push notifications, displayed within the application, etc.

In some embodiments, the application in which the stations exists actively monitors consumer behavior to automatically adjust the cadence of communications. The application may monitor how a consumer interacts with provided content and accordingly adjust the kinds/categories of content, form of content, or aggressiveness of content delivery in order to provide consumers with more content that interests them and less content they ignore. For example, if the application detects that a resort guest frequently actively engages with the content he receives, the resort guest may receive content more frequently. Conversely, if the resort guest appears to be ignoring or immediately dismissing all push notifications the guest receives, delivery of push notifications may be halted. The application may also monitor the consumer's location and environmental data and adjust the kinds of content, form of content, or aggressiveness of content delivery based on such factors. For example, in some embodiments, if the resort guest is detected as being located within the resort spa or in a meeting being held in a resort conference room, or if the guest has indicated he is with his young family and it is after midnight, the delivery of content may be temporarily suspended.

In the provided example, consumers (e.g., resort guests) may carry smartphones or other mobile computing devices that detect, and optionally connect to, the resort's wireless network upon entering the resort. The wireless network may be, for example, a Wi-Fi® network. Additionally or alternatively, the wireless network may be, for example, a network of low-energy Bluetooth signals generated by a plurality of wireless sensor beacons (such as, for example, iBeacons™ or Gimbals™). In such instances, the front-end application may detect the wireless connection, relay this connection to the application server as a form of location data, and thereafter connect to the resort's network station automatically or upon selection of the network station by the consumer.

In another non-limiting example, the partner venue 120b may be a sports arena. The sports arena may update the content available on its network station 110b for every new event taking place within the arena. For example, on the day of a men's NBA® basketball game, the arena may post to its network station 110b information about the two competing teams, such as the roster, the injured list, and the stats for each player. During the game, the arena may provide content about each player's game day stats nearly in real time and provide instant replay video of big plays. The arena may also provide one or more transactional systems within the network station 110b, for example, so that consumers 130 in the stands can electronically pay for the hotdogs, sodas, and popcorn purchased from the arena's walking vendors. The network station 110b may also offer interactive activities, for example, a sports-related trivia game with which consumers 130 can interact while waiting for the game to begin. The trusted affiliates 140c, 140d, may be, for example, nearby restaurants and bars offering post-game deals, a reputable online retailer offering custom-made jerseys, or offers from local taxi companies to help ensure consumers 130 get home safely after the game.

Upon approaching the arena, consumers 130 may be able to open their front-end application, search for nearby partner entities, and select the arena from a listing or graphical display in order to connect to the arena's station. In order to have access to some of or all the content on the arena's network station, consumers 130 may need to enter authentication information, such as, for example, a code printed on their tickets for the game. Upon connecting to the arena's network station, a consumer 130 may receive points or credits for visiting a partner entity. The consumer 130 may receive further points or credits for using the network station to perform transactions, such as buying hotdogs at the arena, for viewing ads posted by trusted affiliates, or for redeeming one or more of the offers or invitations received through the application.

In some embodiments, consumers 130 connect to the global network and to the arena's station via a mobile wireless or Wi-Fi connection. In order to avoid loss-of-signal problems frequently encountered when thousands of mobile device users are present within an arena, in some embodiments, consumers entering the arena may connect their mobile devices to a network of low-energy Bluetooth signals generated by a plurality of wireless sensor beacons positioned throughout the arena. These beacons may, advantageously, provide improved connectivity as well as more accurately identify the location of a consumer. The use of beacons may allow for more refined location-based filtering of content. For example, food and drink specials may be provided to a consumer when it is detected that the consumer has walked over to the concession stand within the arena.

### System Modules

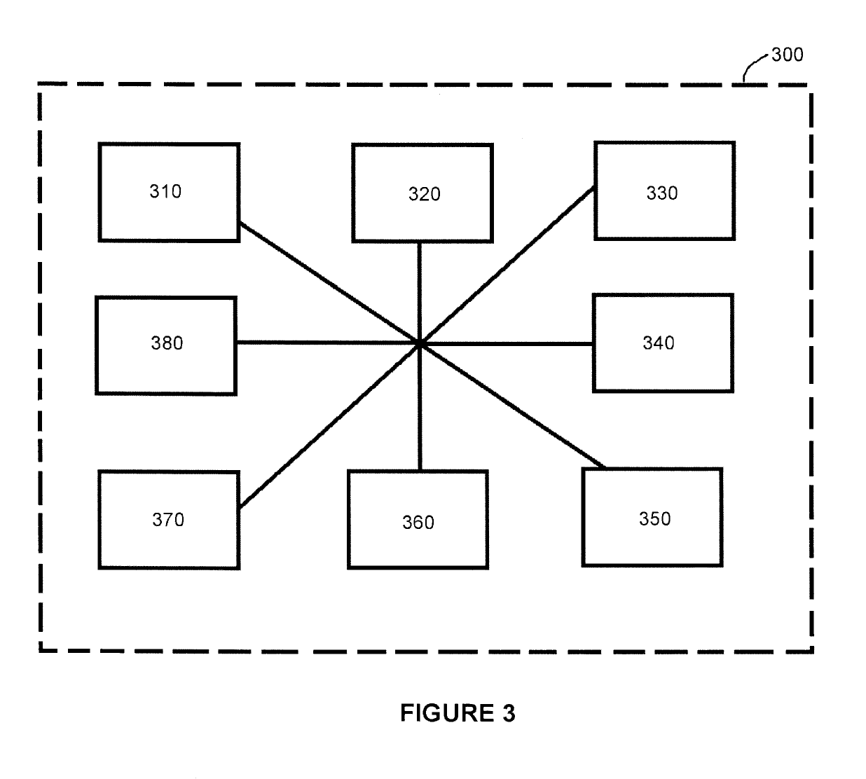

FIG. 3 provides a functional block diagram of one embodiment of a content delivery ecosystem. The block diagram highlights some of the various modules that may be present within the ecosystem. In various embodiments, only one or some of the described modules may be present. In some embodiments, additional modules may also be present. The various modules are described here in functional terms for ease of description. It is contemplated that such functionality may be performed by hardware, software, or a combination of both.

In some embodiments, the content delivery ecosystem 300 includes one or more of: a station creation module 310, a network-wide consumer profile module 320, a station-specific consumer profile module 330, an entity identification module 340, an entity access module 350, a trusted affiliate module 360, a consumer interfacing module 370, and a communication module 380.

In some embodiments, a station creation module 310 is provided to facilitate the creation and maintenance of network stations. In some embodiments, the station creation module 310 is configured to receive requests from entities looking to join the global network. Within the station creation module 310, a network administration reviews requests to determine if requesting entities are appropriate for inclusion in the network. In some embodiments, if approved, an entity must complete a registration process to become a partner entity. Once a partner entity, the entity is provided access to a database of templates and API tools/libraries enabling partner entities to create a customized sub-network (i.e., micro-application or network station) within the global network. The network station may include passive content such as text, images, and videos for viewing. The station may also include interfaces for performing transactions, engaging in communications, and otherwise actively interacting within the station. In some embodiments, the network administrator may review the partner entity's station to ensure a certain level of quality and/or decorum is present.

In some embodiments, a network-wide consumer profile module 320 is provided. Within the network-wide consumer profile module 320 of some embodiments, the consumer is able to upload a profile picture, enter and save biographical information, and/or select content preferences. In some embodiments, content preferences are categories of information about which the consumer is interested in receiving information in the form of invitations or commercial offers. As a non-limiting example, content preferences may include broad categories such as restaurants, nightlife, family activities, entertainment, hotels, transportation, fashion, etc. Additionally or alternatively, content preferences may include narrower categories, such as, for example, vegetarian cuisine, men's high fashion, salon services, etc. In some embodiments, when a consumer creates a user profile, the consumer can select one or more content preferences, for example, by clicking on boxes next to categories of interest. In certain embodiments, a consumer can also enter and save content delivery preferences to indicate how aggressively and in what form content should be delivered through the application. For example, a consumer may be able to specify which, if any, of the following they wish to receive: e-mails, text messages, and/or push notifications, and the frequency with which content should be delivered, such as, for example, as soon as it is available, hourly, twice daily, etc. Additionally or alternatively, in certain embodiments, a consumer can select and save one or more viewing lenses through which they wish to filter content. In various embodiments, the information entered into a consumer's profile is saved within a database or server, and the information is remembered by the system in every network station the consumer enters. In some embodiments, a consumer may be able to create more than one user profile, for example, the consumer may be able to create a profile for work and a profile for home/leisure. In some embodiments, when creating a profile, a consumer may be able to integrate with, or pull information from, an existing user profile on a third-party system, such as, for example, Facebook, LinkedIn, or Twitter.

Additionally or alternatively, in some embodiments, a station-specific consumer profile module 330 is included within the ecosystem 300. In some embodiments, such as, for example, embodiments in which a consumer has more than one user profile, the consumer is invited to select which user profile to use when the consumer opens the application or connects to a network station. In some embodiments, the consumer's selection is saved for all repeat visits to the network station. In some embodiments, the selection is saved indefinitely; in other embodiments, the selection is saved for a selected period of time, such as, for example, for the duration of a consumer's visit to the respective partner entity. In some embodiments, a consumer may be able to modify the information saved within the consumer's user profile and save the modified profile for use, specifically, within a particular network station.

In some embodiments, an entity identification module 340 is present. In some such embodiments, the entity identification module 340 receives location data from a consumer's computing device. The location data may be generated by the device using information received from GPS or wireless mobile networks. Alternatively, the location data may be entered by a consumer. For example, the consumer may enter a current address or partial address or an address or partial address of a location they plan to visit in the future. The module 340 then searches a database for nearby partner entities. The database may include, for example, the name or other identifier for every partner entity and corresponding location data, such as the respective partner entity's address, GPS coordinates, or orthogonal coordinates. The consumer may alternatively enter the name of the entity they are visiting or plan to visit. The module 340 then searches a database for partner entities having the same or similar name. In another embodiment, the module 340 receives information about wireless signals or networks detected by the computing device, and this information is treated as location data. For example, in some embodiments, the computing device may detect and/or connect to a Wi-Fi network, or receive Bluetooth, low-energy Bluetooth, RF, or near field communication signals from a transmitter within an entity. In one embodiment, the module automatically connects the consumer to the station of: the closest partner entity, the partner entity matching the specific name or address entered by a consumer, or the partner entity transmitting the detected wireless signals. In other embodiments, the module provides data enabling the consumer's computing device to display one or more partner entities matching the search criteria. In some embodiments, the partner entities are displayed in a list. In other embodiments, the one or more partner entities are displayed on a map or other graphical display. In some embodiments, the module is configured to receive a consumer's selection of a partner entity and/or network station.

A station access module 350 may be present is some embodiments. In such embodiments, the module 350 is configured to receive a request from a consumer's computing device to access a particular network station. This request may be generated by the consumer using a user interface on the computing device, or the request may be generated automatically by the computing device when only one station is identified during the entity identification process described above. In response to the request, the module of some embodiments provides the permissions necessary to connect and/or establishes the connection. In other embodiments, the module analyzes location data received from the consumer's computing device. If the consumer is located within acceptable location boundaries, for example, within or near a partner entity, the module will provide the consumer with access to the particular partner entity's station. In other embodiments, the module additionally or alternatively performs an identification verification step before granting access. For example, in some embodiments, the module 350 requests identification data from a consumer trying to connect. If the partner entity is a hotel or resort, the requested identification data may be, for example, a hotel room number and last name on the reservation. If the partner entity is a sports arena, theater, or musical venue, for example, the requested identification data may include a reservation confirmation number or an assigned seat number and the last name on the reservation. In some embodiments, if it is confirmed that the consumer has authority/permission to be within a particular partner entity's facilities, the consumer will be granted permission to connect to the partner entity's network station. Otherwise, the access may be restricted.

Some embodiments include a trusted affiliate module 360. The module 360 of some embodiments includes a web-based interface through which the partner entity can generate a list of recommended trusted affiliates and through which the trusted affiliates can generate and/or upload commercial advertisements (print, video, or sound), offers, and invitations. In certain embodiments, other vendors may also be able to upload advertisements, offers, and invitations. In some embodiments, each trusted affiliate and/or other vendor may also be able to enter informative content into the network station, such as, for example, its hours of operation.

The module 360 of some embodiments includes a filter, which analyzes each offer and invitation and identifies the nature or category of the vendor and/or the offer/invite. In other embodiments, a trusted affiliate, partner entity, or network administrator assigns one or more categories to each trusted affiliate at the time of becoming affiliated with a particular network station. In other embodiments, the categories of each vendor listed within the network are identified and pulled from a third party application such as Yelp®. In other embodiments, categorization of vendors is crowd-sourced and performed by consumers using the system. In still other embodiments, the trusted affiliate, partner entity, or network administrator assigns one or more categories to each advertisement, offer, and invitation that a trusted affiliate creates.

In some embodiments, once the relevant category or categories of the offer of a vendor is identified, the module 360 identifies connected consumers who should be targeted by the offer or invitation. In some embodiments, such determinations are made based, at least, on the current location of the consumer. In some embodiments, such determinations are additionally made based on content preferences or user profile information entered by each consumer connected to the network station. Additionally or alternatively, in some embodiments, such determinations are made based on a user's browsing, rating, or location history. Such historical data may be tracked by the application and saved within a database or server, for example, with the user's profile information. In some embodiments, a consumer will be targeted for content from a particular vendor if they have frequented the vendor or vendors of the same category in the past and/or if they have provided positive reviews or ratings to the vendor or vendors of the same category in the past.

The module 360 of certain embodiments includes further filters, referred to as lenses, for further filtering and distilling the listing of trusted affiliates or other vendors and the respective offers visible to each consumer. In some embodiments, one or more lenses may be selected by a consumer from an available list of filters to narrow the content provided to the consumer based, for example, on the consumer's tastes, interests, and/or affiliations.

The module 360 of some embodiments then delivers the offer or invitation to the targeted consumers. In some embodiments, the module 360 aggregates the offers and invitations targeted to each consumer such that one message is sent to the consumer periodically, for example each day or each week, containing the offers and invitations that have been deemed relevant to the particular consumer. In some embodiments, the frequency of the content delivery is determined based on content delivery preferences stored within a consumer's profile.

In some embodiments, a consumer interfacing module 370 is also provided. Through this module, a connected consumer may be able to interact with a particular network station. For example, this module 370 may provide the functionality needed to send offers, invitations, and other alerts to connected consumers. Other alerts may include, for example, important information about services or goods available within the partner entity's facilities. Such alerts may be sent via email, text, push notifications, or as an alert within the application. The consumer interfacing module 370 may also include the user interface of the application, which enables consumers to navigate through, and interact with, the content available on a station or in the global network. The module 370 may also include the interfaces needed to communicate and perform transactions within the global network and individual network stations. In some embodiments, the consumer interfacing module 370 also includes functionality to actively monitor how a consumer interacts with delivered content. The module of some embodiments tracks messages delivered to a consumer, monitoring when the message is opened and/or whether the consumer interacts with the message, for example, by clicking any links embedded within the message. In some embodiments, the module stores such tracking data in a database and uses it to adjust the kinds of content, form of content, or aggressiveness of content delivery. The application may also monitor the consumer's location and environmental data and adjust the kinds of content, form of content, or aggressiveness of content delivery based on such factors.

Additionally, some embodiments have a communication module 380. Some embodiments of the communication module 380 are configured to establish communication connections between two or more participants connected to a particular station. The communication module 380 may include, for example, a message board, file-sharing system, chat room, private messaging service, or micro-blog forum. In one non-limiting example, in which the consumer is a patient and the partner entity is a healthcare facility, a patient may be able to visit a chat room within the network station to exchange messages and find fellowship with a group of other patients suffering from the same condition. The patient may be able to visit a pinboard-style message board to view and post funny or inspirational images. The patient may also be able to establish a secure, private communication with a healthcare provider to ask a medical question. The patient may further be able to visit the social networking micro-blog forum to post a short message available for all network station participants to read or to read a message posted by the cafeteria indicating what the day's lunch specials are.

In some embodiments, the functionality of some of the modules may be available within a software development kit (SDK) for integration into other third-party applications. For example, in some embodiments, the trusted affiliate module 360 and the consumer interfacing module 370 may be available for white-labeling and/or integration into an application such as a hotel chain's existing reservation application. In some embodiments, an available SDK kit may include tools to integrate a consumer profile module, the entity identification module 340, the station access module 350, the communication module 380, the trusted affiliate module 360, and/or the consumer interfacing module 370 into a third-party application.

### Example Operations

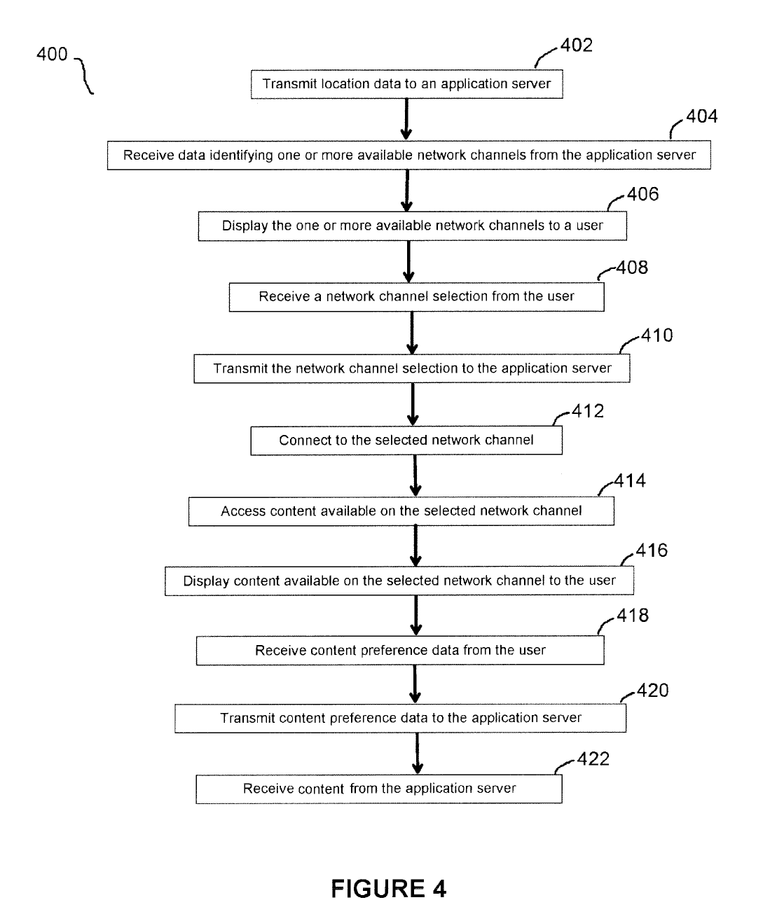

FIG. 4 provides a flow chart depicting one embodiment of a computer-implemented method of receiving content. The method may be performed, for example, by a consumer's smartphone or other computing device on which a content delivery application has been loaded.

In some embodiments, the method 400 includes transmitting location data to an application server, as shown at block 402. In some embodiments, the location data may be in the form of GPS coordinates or geographic coordinates generated by the consumer's computing device. In other embodiments, the location data may be a city or street address or venue/entity name entered by a consumer into the computing device via a user interface. In still other embodiments, the location data may be data conveying the computing device's connection to a particular local wireless network or detection of a particular wireless signal. For example, in some embodiments, the computing device may detect and/or connect to a Wi-Fi network, or receive low-energy Bluetooth, or other Bluetooth, RF, or near field communication signals from a transmitter within an entity's facilities. In such embodiments, the application server can identify that the computing device is located within or near a particular entity's facilities from the device's detection of the wireless networks or signals.

At block 404, the method 400 of some embodiments includes receiving data identifying one or more available network stations from the application server. In some embodiments, the one or more available network stations are identified at least in part from the location data. For example, in one embodiment, the computing device only receives data identifying stations controlled by any partner entities located within a particular radius of the location identified by the location data. In another embodiment, the computing device receives data identifying any network stations controlled by any partner entities having the same or similar name entered by the consumer. In still another embodiment, the computing device receives data identifying any stations controlled by any partner entities known to transmit the wireless signals detected by the computing device.

In some embodiments, the one or more available network stations are displayed to a user (i.e., consumer) via a user interface, as depicted at block 406. The available network stations may be displayed in a list, map, or other graphical form. The method 400 may also include receiving a station selection from the consumer via a user interface, as depicted at block 408. At block 410, the method includes transmitting the consumer's station selection to the application server. As shown at block 412, the computing device connects to the selected network station. In some embodiments, if the computing device receives data identifying only one network station, block 406 (displaying available network stations), block 408 (receiving a consumer's selection), and block 410 (transmitting the consumer's selection) are omitted. At block 412, the computing device connects to the identified network station.

Once connected, the computing device can access content available on the selected network station and display said content to the consumer via a user interface, as shown at blocks 414 and 416, respectively.

Some embodiments further include receiving content preference data from a consumer via a user interface, as shown at block 418. As shown at block 420, in some such embodiments, the computing device transmits content preference data to the application server. At block 422, the computing device receives content, such as an offer or invitation, from the application server. In some embodiments, the delivered content is selected based, at least in part, on the consumer's location. The delivered content is also selected, in part, on the consumer's selected network station. In some embodiments, the delivered content is additionally selected based, at least in part, on the consumer's content preference data. In some embodiments, the delivered content is generated by a partner entity or a trusted affiliate and selected for the consumer automatically by a computer processor, such as, for example, by a network station computer or the application server.

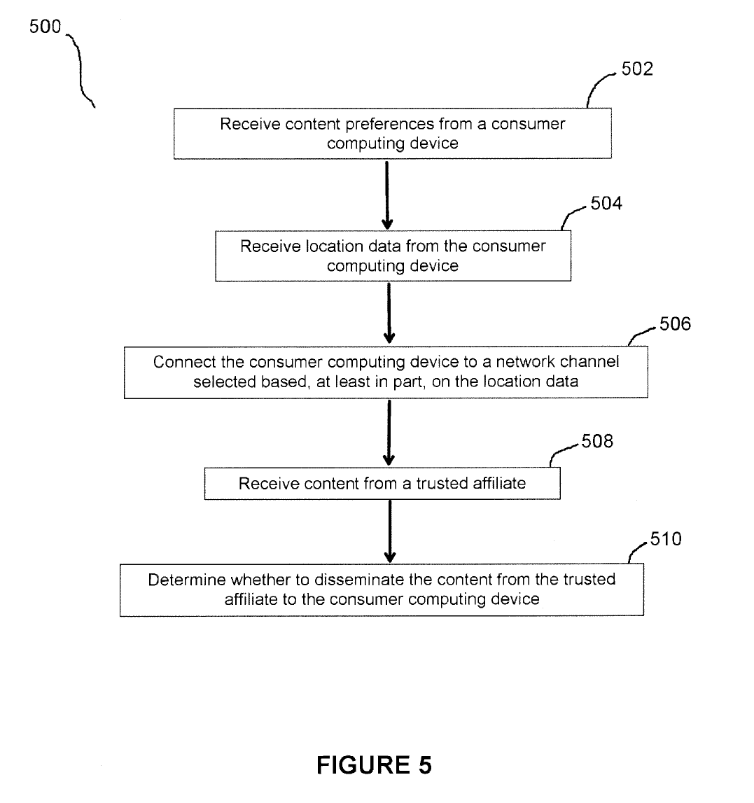

FIG. 5 provides a flow chart depicting one embodiment of a computer-implemented method of delivering content to consumers. The method 500 may be performed, for example, by a mobile or web-based server. In some embodiments, the method 500 includes receiving content preferences from a computing device, such as shown at block 502. The computing device may be a consumer's smartphone, tablet, in-vehicle computer, wearable mobile device, or other device. The content preferences may have been selected by a consumer interfacing with the computing device or may be derived from information available in a consumer's profile and/or data gathered through the consumer's usage of the application. As shown at block 504, the method 500 of some embodiments further includes receiving location data from the computing device. The location data may have been generated by the computing device or entered by a consumer via a user interface on the computing device. At block 506, the method 500 includes connecting the computing device to a network station. The network station is selected based, at least in part, on the location data received from the computing device. The act of connecting the computing device to a network station may include establishing a connection between a computing device and a repository of content stored in a server, or it may include, for example, sending the computing device the permissions or ISP address needed to connect and allowing the computing device to connect.

In some embodiments, the network station is at least partially controlled by an entity. For example, the network station may have been created or sponsored by a particular entity and content within the station may have been created, edited, or approved by the entity. In some such embodiments, the method 500 further includes receiving content from a trusted affiliate, as shown at block 508. The trusted affiliate of various embodiments is granted access to the network station by the entity. The method 500 may further include block 510. At block 510, a filter associated with the server or network station determines whether to disseminate the content from the trusted affiliate to the consumer's computing device. The determination, in various embodiments, is based on location data and the content preferences received from the computing device. For example, the content may only be disseminated if: the consumer's computing device is within a particular location range; the content has been tagged as falling into a particular category matching the consumer's selected preferences; and/or the content is delivered in a format the consumer has indicated he/she is willing to receive. In some embodiments, the method further includes transmitting the content to the computing device, if the filter determined that the content should be disseminated to the device. In some such embodiments, transmitting the content to the computing device involves transmitting a commercial offer to the consumer computing device via email, SMS text, push notification, or through an application interface (such as for example, the front-end application disclosed herein or a third-party application such as Facebook).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

### Example User Interface

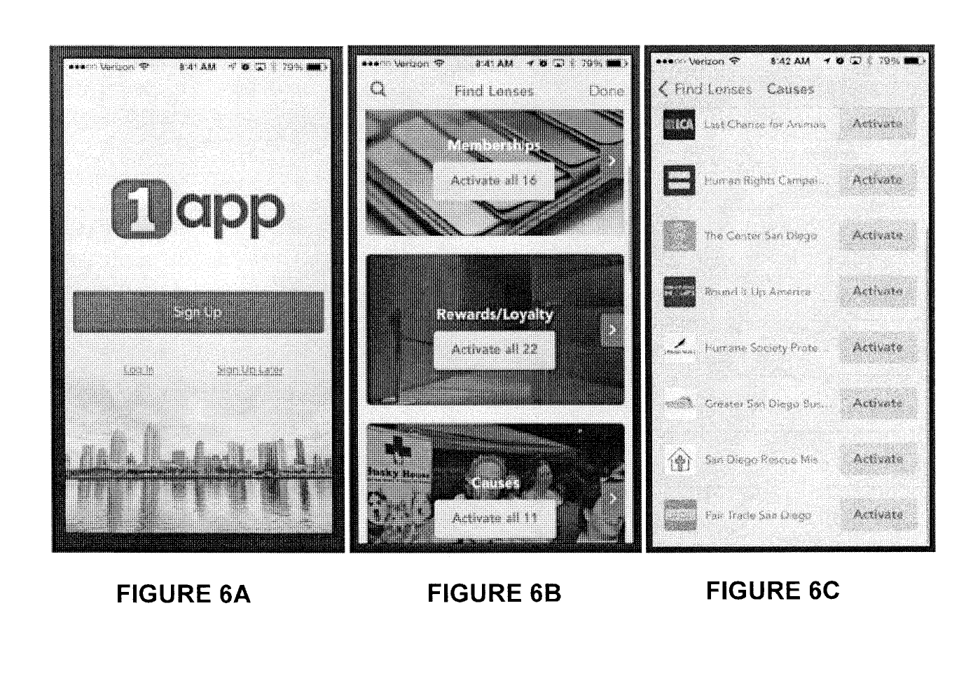

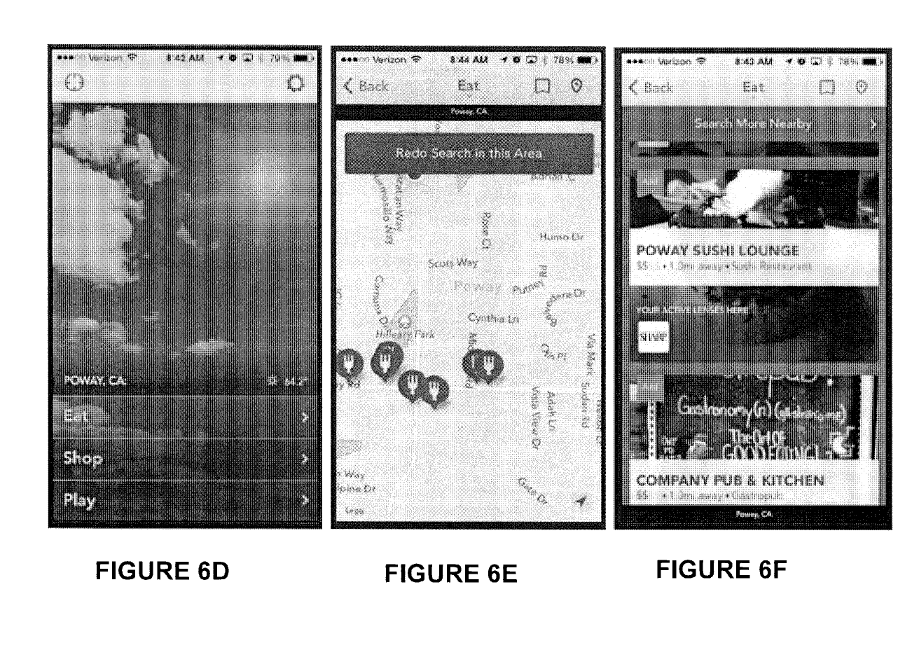

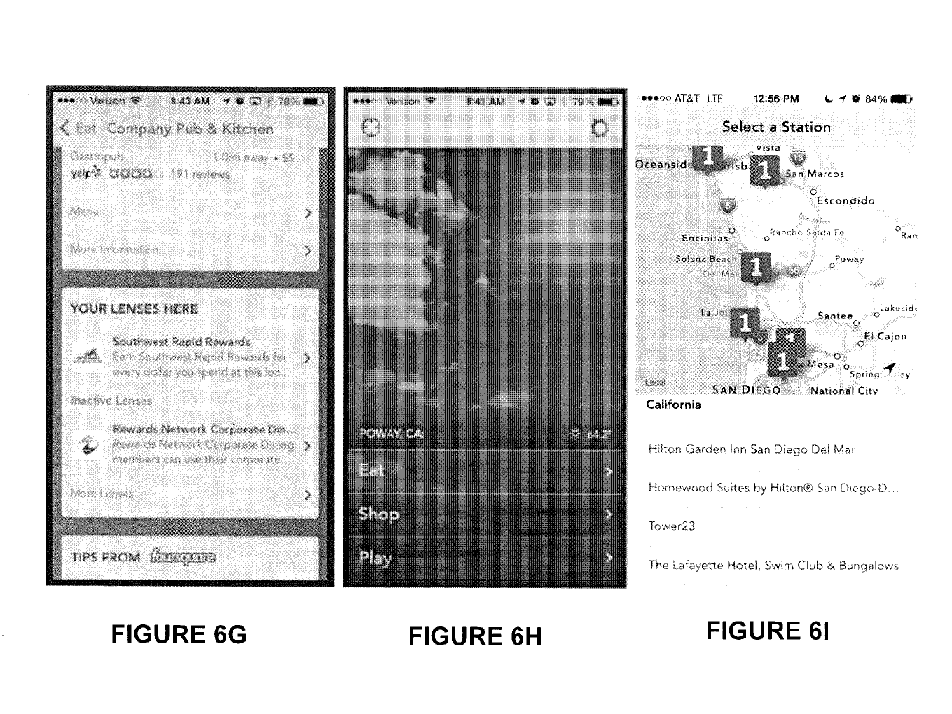

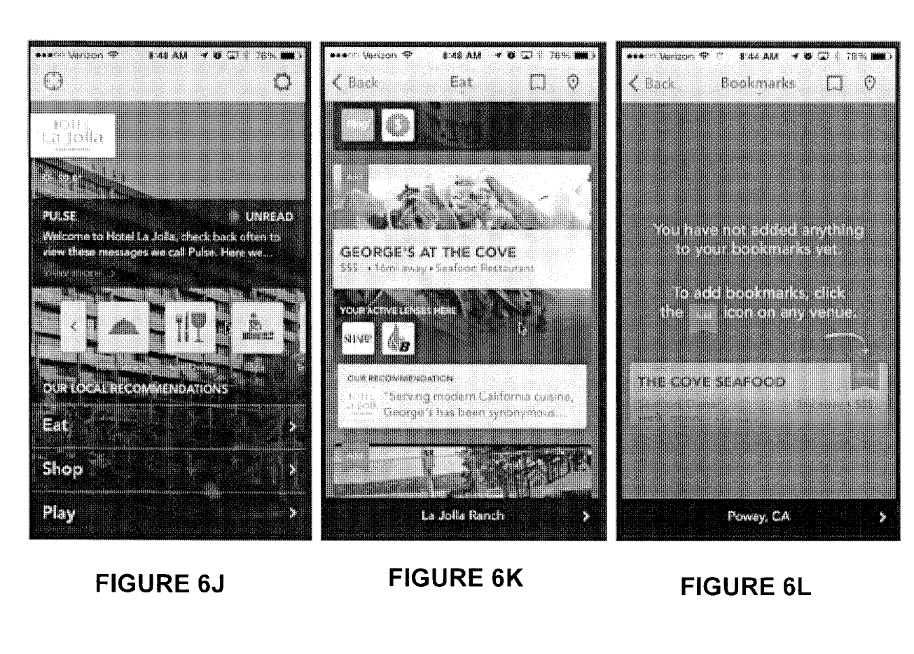

FIGS. 6A-6I depict examples of one non-limiting embodiment of the application described herein. In some embodiments, the application is an internet-based application having a front-end user interface configured for download onto a smartphone, tablet, or other mobile computing device. As shown in FIG. 6A, upon opening the application, the consumer may be prompted to sign up or login. Alternatively, the consumer may select to sign up later and proceed into the application. If the consumer does not sign up, he or she may not be able to utilize certain features of the application; for example, the consumer may not be able to create a user profile, save content preferences, or save favorites. Once signed up, the consumer may be able to remain signed in so that he or she can bypass the login screen during future use. Upon signing up, the consumer may be prompted to create a user profile and select user preferences, such as, for example, lenses (i.e., content filters) of interest to the consumer. In some embodiments, lenses may fall into one of several broad categories, as shown in FIG. 6B, such as, for example, memberships, rewards/loyalty, causes, foodie, special diet/health, award winning, or other. The consumer can activate all lenses within a category or select the category, such as, for example, the Causes category, as selected in FIG. 6C, in order to view and select particular lenses falling within said category. In some embodiments, once one or more lenses are activated, the selections will be remembered by the application and will be applied to create a curated user experience within the global network application and within individual partner entity stations. In some embodiments, the consumer may modify the list of activated lenses at any time by selecting a settings icon or user profile icon within the application.

One embodiment of a main screen or home screen is shown in FIG. 6D. The application of various embodiments communicates with the mobile computing device to detect and determine whether location data is available for the device. If the device is not transmitting location data, the consumer will be prompted to enable location detection via GPS or a mobile/wireless signal. The user may also be prompted to enable Bluetooth on the device. The application of some embodiments will then use location data received from the device to identify the location of the consumer. For example, as shown in FIG. 6D, the consumer is in Poway, Calif. The current time and weather conditions, local news headlines, or other location and/or temporal information may be displayed on the home screen. Additionally or alternatively, from the home screen, the consumer may browse vendors within various categories such as eat/restaurants, shop, and play/activities. In such a manner, a consumer who is not entering a particular partner entity, but rather, sitting at home, for example, may still be able to search the tailored content available within the application.

As shown in FIGS. 6E and 6F, if the consumer selects one of the categories of vendors, vendors of potential interest to the consumer will be displayed in map (FIG. 6E) and/or list (FIG. 6F) format. In some embodiments, the consumer's current location is the default location data, which the application uses to filter vendors for display; however, the consumer may modify the vendor search to be performed in any area of interest to the consumer. The search results are curated to be user-specific, at least by limiting the vendor search results by category of vendor (e.g., eat, shop, or play), location, and the consumer's activated lenses. In some embodiments, only vendors having a deal for, approved relationship with, or endorsement from at least one of the consumer's activated lenses will be shown.

As shown in FIG. 6G, when a consumer selects a vendor from the list or map, more detailed information about the vendor is displayed. For example, in some embodiments, data available from a third party application such as Yelp® and/or Foursquare® is displayed, providing the consumer with data such as: the vendor's distance from the consumer, the relative cost, hours of operation, the menu, tips and ratings from other users, etc.

As further shown in FIG. 6G, the consumer may also be able to see active lenses affiliated with the vendor. The consumer may be able to select any of the lenses to learn more about the lens and to view details about any offers available from the lens with the respective vendor. For example, if the lens is a deal lens, selecting the lens will display the details of the deal such as $5 off the bill. If a consumer wishes, they may click on the lens again to view all deals provided by, or vendors associated with, the particular lens. In some cases, the vendor detail page of FIG. 6G will be displayed with not only the active lenses visible but also a listing of inactive lenses associated with the vendor, so a consumer is able, if desired, to activate the lens when at the vendor to ensure he/she does not miss out on a deal.

Returning to the home screen, shown again in FIG. 6H, the consumer may select the scope icon to search for a partner entity station with which to connect. In some embodiments, such as shown in FIG. 6I, the stations are displayed in map and/or list format.

Upon selecting a station, the consumer may enter the micro-application of a partner entity, as described elsewhere herein. As shown in FIG. 6J, within the station, the partner entity may generate its own content, recommendations, photographs, etc. in order to create a unique look and feel. A carousel of information about the partner entity may also be available for browsing by the consumer. In some embodiments, such as shown in FIG. 6K, the active lenses of a consumer are remembered within and outside of partner stations. In such embodiments, the recommendations of the partner entity are distilled for the consumer to only show recommendations matching the consumer's active lenses.

As shown in FIG. 6L, in some embodiments, consumers may be able to bookmark vendors of interest to them in order to save the vendors and easily return to their respective vendor pages. Each consumer may also be able to mark the vendor as a favorite and add the vendor to a list created by the consumer. This is just one non-limiting example of a user-interface having some of the functionality described elsewhere herein.

Those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more example embodiments, the functions described may be implemented in hardware, software, or firmware executed on a processor, or any combination thereof. For example, certain embodiments may comprise a computer program product for performing the operations presented herein. Such a computer program product may comprise a computer readable medium having instructions stored and/or encoded thereon, the instructions being executable by one or more processors to perform the operations described herein. When the functions described herein are implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Further, it should be appreciated that modules and/or other appropriate means for performing the methods and techniques described herein can be downloaded and/or otherwise obtained by a device as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a device can obtain the various methods upon coupling or providing the storage means to the device. Moreover, any other suitable technique for providing the methods and techniques described herein to a device can be utilized.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes both the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While the above description has pointed out novel features as applied to various embodiments, the skilled person will understand that various omissions, substitutions, and changes in the form and details of the device or process illustrated may be made without departing from the scope of the invention. The claims are not limited to the precise configuration and components illustrated above. Therefore, the scope of the invention is defined by the claims that follow rather than by the foregoing description. All variations coming within the meaning and range of equivalency of the claims are embraced within their scope.

1. A computer-implemented method of distributing content to a user of a single computer application, comprising:
transmitting location data to a remote computer;
receiving identification data from the remote computer identifying one or more available network stations available within the single computer application, wherein each of the one or more network stations is created or sponsored by a respective one or more partner entities, and wherein the one or more available network stations are identified at least by a name and location of the respective partner entity;
displaying the identification data of the one or more available network stations to a user;
receiving a network station selection from the user, wherein the selected network station has been created or sponsored by a particular partner entity;
transmitting the network station selection to the remote computer;
connecting to the selected network station, wherein the selected network station comprises content created or approved by the particular partner entity;
receiving a filtered portion of the content created or approved by the particular partner entity, wherein the filtered portion comprises content determined to be relevant to the user based, at least in part, on content preference data; and
displaying the filtered portion of the content to the user.

2. The computer-implemented method of claim 1, further comprising:
receiving content preference data from the user; and transmitting content preference data to the application server.

3. The computer-implemented method of claim 1, wherein the filtered portion of the content displayed to the user is further filtered to comprise content determined to be relevant to the user based, at least in part, on the content preference data of the user and: the user's location data, environmental data, or both.

4. The computer-implemented method of claim 1, wherein the content created or approved by the particular partner entity comprises recommendations of one or more of: things to see, activities to do, places to shop, and places to eat.

5. The computer-implemented method of claim 1, wherein the remote computer determines which portion of the content is relevant to the user.

6. The computer-implemented method of claim 1, further comprising receiving an offer from the remote computer, wherein the offer is generated by a partner entity or a trusted affiliate vendor and selected for the user, and wherein the offer is selected by the remote computer based, at least in part, on the user's selected network station.

7. The computer-implemented method of claim 6, wherein the offer is selected by the remote computer based, at least in part, on the user's selected network station and the user's location.

8. The computer-implemented method of claim 6, wherein the offer is selected by the remote computer based, at least in part, on the user's selected network station and the user's content preference data.

9. The computer-implemented method of claim 6, wherein the offer is a discount, a deal, or an invitation.

10. The computer-implemented method of claim 6, wherein the offer is received via an e-mail, a text message, a push-notification, or an alert within the computer application.

11. A non-transitory machine-readable storage medium embodying a set of instructions that, when executed by a processor, cause the processor to perform operations, the operations comprising:
transmitting location data to a remote computer;
receiving identification data from the remote computer identifying one or more available network stations available within a single computer application, wherein each of the one or more available network stations is created or sponsored by a respective one or more partner entities, and wherein the one or more available network stations are identified at least by a name and location of the respective partner entity;
displaying the identification data of the one or more available network stations to a user;
receiving a network station selection from the user, wherein the selected network station has been created or sponsored by a particular partner entity;
transmitting the network station selection to the remote computer;
connecting to the selected network station, wherein the selected network station comprises content created or approved by the particular partner entity;
receiving a filtered portion of the content created or approved by the particular partner entity, wherein the filtered portion comprises content determined to be relevant to the user based, at least in part, on content preference data; and
displaying the filtered portion of the content to the user.

12. The non-transitory machine-readable storage medium of claim 11, further comprising:
receiving content preference data from the user; and
transmitting content preference data to the application server.

13. The non-transitory machine-readable storage medium of claim 11, wherein the filtered portion of the content displayed to the user is further filtered to comprise content determined to be relevant to the user based, at least in part, on the content preference data of the user, and: the user's location data, environmental data, or both.

14. The non-transitory machine-readable storage medium of claim 11, wherein the content created or approved by the particular partner entity comprises recommendations of one or more of: things to see, activities to do, places to shop, and places to eat.

15. The non-transitory machine-readable storage medium of claim 11, wherein the remote computer determines which portion of the content is relevant to the user.

16. The non-transitory machine-readable storage medium of claim 11, further comprising receiving an offer from the remote computer, wherein the offer is generated by a partner entity or a trusted affiliate vendor and selected for the user, and wherein the offer is selected by the remote computer based, at least in part, on the user's selected network station.

17. The non-transitory machine-readable storage medium of claim 16, wherein the offer is selected by the remote computer based, at least in part, on the user's selected network station and the user's location.

18. The non-transitory machine-readable storage medium of claim 16, wherein the offer is selected by the remote computer based, at least in part, on the user's selected network station and the user's content preference data.

19. The non-transitory machine-readable storage medium of claim 16, wherein the offer is a discount, a deal, or an invitation.

20. The non-transitory machine-readable storage medium of claim 16, wherein the offer is received via an e-mail, a text message, a push-notification, or an alert within the computer application.
